(19) United States
(12) Patent Application Publication
(10) Pub. No.: US 2026/0196048 A1
(43) Pub. Date: Jul. 9, 2026

(54) METHOD AND SYSTEM TO GENERATE CONTENT BASED ON SURROUNDING ENVIRONMENT

(71) Applicant: Mozo, Inc., San Diego, CA (US)

(72) Inventor: Richard Ostrup, San Diego, CA (US)

(73) Assignee: Mozo, Inc., San Diego, CA (US)

(21) Appl. No.: 19/009,909

(22) Filed: Jan. 4, 2025

(51) Int. Cl. G06V 20/52; G06T 7/20; G06T 7/62; G06T 7/70; G06T 7/90; G06V 10/82

(52) U.S. Cl. CPC G06V 20/52; G06T 7/20; G06T 7/62; G06T 7/70; G06T 7/90; G06V 10/82; G06V 2201/07

(57) ABSTRACT

This application discloses a device to analyze the surrounding environment based on images and sounds and broadcast content to a user based on the result of the analysis. The device records a video of surrounding environment and analyze images in frames to identify objects and environmental conditions, and/or record a soundtrack of surrounding environment and analyze sounds in the soundtrack to identify sounds and meaning of language. The results are used to make a selection from a content library, or to generate content using artificial intelligence. The selected or generated content is in audio or video form and is broadcasted to a screen and/or speaker.

### BACKGROUND OF THE INVENTION

### Field of the Invention

This invention is in the field of content delivery and projection. The invention concerns a device capable of generating content according to input and outputting content in audio and video form. The device also projects sound in a particular manner, thereby delivering sound and content tailored to a specific person and not anyone nearby.

### Description of the Related Technology

Delivering sounds to a particular person while avoiding other people nearby is a need addressed by many. For adults driving children in vehicles, there are screens and projectors installed behind the driver to entertain the occupants of the back seat, who often are children. In these instances, sound delivery is necessary for the non-drivers, but the driver preferably does not hear the same sounds.

At the same time, sounds are often used to sooth small children, in particular infants and toddlers. Songs, lullabies, and rhymes are used regularly, giving rise to the term “nursery rhymes”. Delivery of such sounds to your children is desirable, and so is the desire to keep such sounds away from others, especially adults, who surround young children.

The need to deliver sounds to a specific person but not to others in the near vicinity is clearly demonstrated by various projects promising sound delivery “like a headphone” but without one. In other words, the goal is sounds being delivered to the recipient but no one else nearby. Technology used includes a variety of techniques, including sound frequency modification, small speakers, etc.

Since the early 1960s, researchers have been experimenting with creating directive low-frequency sound from nonlinear interaction of an aimed beam of ultrasound waves produced by a parametric array using heterodyning. Ultrasound has much shorter wavelengths than audible sound, so that it propagates in a much narrower beam than any normal loudspeaker system using audio frequencies. Most of the work was performed in liquids (for underwater sound use). A transducer can be made to project a narrow beam of modulated ultrasound that is powerful enough, at 100 to 110 dBSPL, to substantially change the speed of sound in the air that it passes through. The air within the beam behaves nonlinearly and extracts the modulation signal from the ultrasound, resulting in sound that can be heard only along the path of the beam, or that appears to radiate from any surface that the beam strikes. This technology allows a beam of sound to be projected over a long distance to be heard only in a small well-defined area; for a listener outside the beam the sound pressure decreases substantially. This effect cannot be achieved with conventional loudspeakers, because sound at audible frequencies cannot be focused into such a narrow beam.

Children under the age of 8 therefore have sensitivity to higher frequency than adults who care for them. Sounds delivered at higher frequency are more perceptible to children than to adults. To deliver specific sounds to children while avoiding delivering the same sounds to adults nearby, delivering sounds at high frequencies is an option.

When adults care for children in “passive” settings, where the adults provide an eye on the children but do not directly engage them, keeping the child “entertained” while allowing the adult to function in a different capacity increases the experience quality for both of them. For example, a woman taking a child out for a walk in a stroller would be better served if the child is entertained during the walk without disruption. Similarly, an adult driving a car with a child in a child's car seat would be able to focus on driving without worrying about the child if the child is entertained by a different means.

Video and audio content delivery to users for entertainment purposes have been determined by either the user or the broadcaster. A user can choose what content to view or listen to, such as be choosing through a library of content, or the broadcaster chooses what to the broadcast, such as by TV station programming, and the user in turn choose among the available content to view or listen to. This does not allow for continuous content generation, content choice by outside factors, and often requires a user's interaction with a device. In some cases, a user does not desire to interact with a device to choose a different content than what is being delivered. For example, a driver may not want to interact with a screen or button to change channel. A person pushing a stroller with a baby inside may not want to have audio or video content delivered to the baby but does not want to continuously interact with a device to choose or change content.

To provide a solution to the above demands, this invention provides a device that records the surrounding environment, detects images and sounds from the surrounding environment to choose content or generate content and deliver the content to a person.

### Abbreviations

dBSPL: decibel of Sound Pressure Level
TV: television

### SUMMARY

The present invention provides a device capable of taking images and audio recordings from surrounding environment, analyzing and labeling objects, humans and sounds from the images and audio recordings, and choosing or generating content from the labels. Content generation uses an artificial program trained with forward and backward propagation to generate content in audio and image form. The generated content is broadcasted on a speaker and/or a screen.

In particular, the present invention provides a method to generate content to be broadcasted, comprising:
recording, using a camera, a video of a surrounding environment and saving the video as image data;
receiving, by a computing device having a processor, image data of the video;
applying the image data to a first trained neural network model to identify objects present in the image data and identify characteristics of the objects;
associating the identified objects with image identity data and image characteristic data;
inputting the identity data and characteristic data of the objects to an artificial intelligence software to generate content; and
broadcasting the content to a speaker and/or screen,
wherein the content is in audio form, image form, or image form with an associated soundtrack.

In frequently provided embodiments, there is provided a method as above, the method further comprises:
recording, using a microphone, a soundtrack of a surrounding environment and saving the soundtrack as sound data;
receiving, by the computing device having a processor, the sound data of the soundtrack;
applying the sound data to a second trained neural network model to identify sounds present in the sound data and identifying characteristics of the sounds;
associating the identified sounds with identity data and characteristic data;
inputting the identity data and characteristic data of the sounds to an artificial intelligence software to generate content.

In often provided embodiments, there is provided a method as above, the method further comprises marking regions of image data not associated with an identity label as background.

In frequently provided embodiments, there is provided a method as above, wherein identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple.

In often provided embodiments, there is provided a method as above, wherein characteristic data of objects comprises color, size, relative position with other objects in the same image, speed of movement of a particular object, age group, gender.

In frequently provided embodiments, there is provided a method as above, the method further comprises analyzing the identity data and characteristic data for environmental condition and relationship data.

In often provided embodiments, there is provided a method as above, wherein the environmental condition is weather condition and lighting condition, and wherein the relationship data is relationship between humans, humans and animals, humans and objects, animals and animals, and animals and objects.

In frequently provided embodiments, there is provided a method as above, wherein the identity data and characteristic data are inputted into the artificial intelligence software to choose from a library content.

In often provided embodiments, there is provided a method as above, the method further comprises receiving additional information from a computer processor and inputting the additional information into the artificial intelligence software to generate content.

In frequently provided embodiments, there is provided a method as above, wherein the additional information comprises time and date, location, weather forecast, and age or age group of a targeted audience.

In often provided embodiments, there is provided a method as above, the method further comprises marking a part of at least one of identity data, characteristic data, and relationship data as negative input and preventing negative input from being sent to the artificial intelligence software.

In frequently provided embodiments, there is provided a method as above, wherein the video recording is continuous in real time and image data is received in real time, and wherein the sound recording is continuous in real time and sound data is received in real time.

In often provided embodiments, there is provided a system for content selection and generation for human consumption, the system comprising:
a camera;
a processor;
a screen;
a speaker; and
a memory device storing computer-executable instructions that, when executed by the processor, causes the processor to:
   record, using the camera, a video of a surrounding environment and save the video as image data;
   apply the image data to a first trained neural network model to identify objects present in the image data and identify characteristics of the objects;
   associate the identified objects and humans with identity data and characteristic data;
   input the identity data and characteristic data of the objects to an artificial intelligence software to generate content;
   record, using a microphone, a soundtrack of a surrounding environment and save the soundtrack as sound data;
   apply the sound data to a second trained neural network model to identify sounds present in the image data and identify characteristics of the sounds and associating the objects and humans;
   associate the identified sounds with identity data and characteristic data;
   input the identity data and characteristic data of the sounds to an artificial intelligence software to generate content; and
   broadcast the content to the speaker and/or the screen,
wherein the content is in audio form, image form, or image form with an associated soundtrack.

In frequently provided embodiments, there is provided a system as above, wherein identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple and wherein characteristic data of objects comprises color, size, relative position with other objects in the same image, speed of movement of a particular object, age group, gender.

In often provided embodiments, there is provided a system as above, wherein the memory device further causes the processor to analyze the identity data and characteristic data for environmental condition and relationship data.

In frequently provided embodiments, there is provided a system as above, wherein the environmental condition is weather condition and lighting condition, and wherein the relationship data is relationship between humans, humans and animals, humans and objects, animals and animals, and animals and objects.

In often provided embodiments, there is provided a system as above, wherein the memory device causes the processor to input the identity data and characteristic data into the artificial intelligence software to choose from a library content.

In frequently provided embodiments, there is provided a system as above, wherein the processor records the video and the soundtrack in real time.

In often provided embodiments, there is provided a system as above, wherein the memory device further causes the processor to receive additional information from a computer processor and input the additional information into the artificial intelligence software to generate content.

In frequently provided embodiments, there is provided a system as above, wherein the additional information comprises time and date, location, weather forecast, and age or age group of a targeted audience.

### BRIEF DESCRIPTION OF THE DRAWINGS

FIG. 1A illustrates a flowchart of steps to train a neural network to recognize and label certain objects in images.

FIG. 1B illustrates a flowchart of steps to train a neural network to recognize and label certain sounds in soundtracks.

FIG. 2A illustrates a method to extract data from images and soundtrack and to use extracted data to choose from a library of content and broadcast the chosen content.

FIG. 2B illustrates a method to extract data from images and soundtrack and to use extracted data to generate content using artificial intelligence software and broadcast the generated content.

FIG. 3 illustrates a flowchart of steps to detect and identify objects in images using the neural network saved in the last step of FIG. 1A.

FIG. 4 illustrates a flowchart of steps to detect and identify sounds in soundtracks using the neural network saved in the last step of FIG. 1B.

FIG. 5 illustrates a flowchart of steps to generate content from the identified objects and sounds in FIGS. 3 & 4.

FIG. 6 illustrates a machine learning system configured to synthesize content and choose content from a library.

FIG. 7A illustrates a dandelion in grass as recorded in an image.

FIG. 7B illustrates computer data of the same dandelion as in FIG. 7A used for image recognition training.

FIG. 8 illustrates a device according to embodiments herein.

FIG. 9 illustrates another device according to embodiments herein attached to a stroller.

FIG. 10 illustrates another device according to embodiments herein as integrated into a car.

FIG. 11 illustrates another device according to embodiments herein as attached to a middle console of a vehicle.

### DETAILED DESCRIPTION OF CERTAIN INVENTIVE EMBODIMENTS

This present invention is capable of being embodied in various forms. The description below of several embodiments is made with the understanding that the present disclosure is to be considered as an exemplification of the claimed subject matter and is not intended to limit the attached claims to the specific embodiments illustrated. The headings used throughout this disclosure are provided for convenience only and are not to be construed to limit the claims in any way. Embodiments illustrated under any heading may be combined with embodiments illustrated under any other heading.

As used herein, the verb “to comprise” in this description, claims, and other conjugations are used in its non-limiting sense to mean those items following the word are included, but items not specifically mentioned are not excluded.

Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more”.

As used herein in the specification and claims, including as used in the examples and unless otherwise expressly specified, all numbers may be read as if by prefaced by the word “about” or “approximately”, even if the term does not expressly appear. The phrase “about” or “approximately” may be used when describing magnitude and/or position to indicate that the value and/or position described is within a reasonably expected range of values and/or positions.

All dimensions given herein are for illustrative purposes only and in no way will limit the inventions by these dimensions. It is to be understood that the invention may be constructed to have different dimensions than those provided herein and is still within the scope of the embodiments described herein. Drawings are not necessarily drawn to scale.

As used herein, like numerals indicate like components even though the components may be used in different manners or at different places. Where there are multiple components of the same nature, a numeral refers to one, some, or all of the components of the same nature, depending on the context.

All dimensions specified in this specification are by way of example only and not intended to be limiting.

As used herein, “content” refers to stories, songs, images, visual arts, videos, or audio tracks perceivable by humans by ears or eyes.

Embodiments of this application relate to a method to collect information from a surrounding environment, generating audio or visual content from the information collected, choosing pre-recorded content based on collected information, and delivering content in audio and/or visual form.

Embodiments of this application also relate to a device capable of collecting information from a surrounding environment, generating content from the information collected, choosing pre-recorded content based on collected information, and delivering the content of images and/or sounds to a screen and/or speaker.

The device comprises a video recording system, such as a camera, configured to record a video of the surrounding environment. Upon activation of the video recording system, a video is recorded by a camera within the video recording system. The recording is saved as digital data and transmitted to a computer programming product. The camera may comprise a plurality of cameras, with each located at a different location or a different side of the device, such that video recording of the surrounding space from different angles can be obtained. The device also has a microphone with sound recording capability and can record sounds simultaneously with the camera. The screen and the speaker are directed in the same direction, such that a person viewing the screen also has the speaker projecting sounds at them. Multiple speakers may be present.

In an embodiment, the speaker is a targeted speaker, such that sounds from the speaker are directed at a target while the sounds cannot be heard by other people and/or animals nearby. This can be accomplished by a targeted speaker as disclosed in U.S. Pat. Nos. 11,475,574, 11,979,722, 12,015,904, which are incorporated herein in their entireties.

The device has a computing processor with stored instructions to receive videos from the camera and soundtracks from the microphone. The computing processor recognizes image data and sound data from the videos and soundtracks. Using this information, the computing processor chooses from a stored library and broadcasts sounds or videos with sounds to the screen and/or the speaker. Alternatively, the processor uses deep learning models to create a story from the input information and broadcasts sounds or videos with sounds to the screen and/or the speaker.

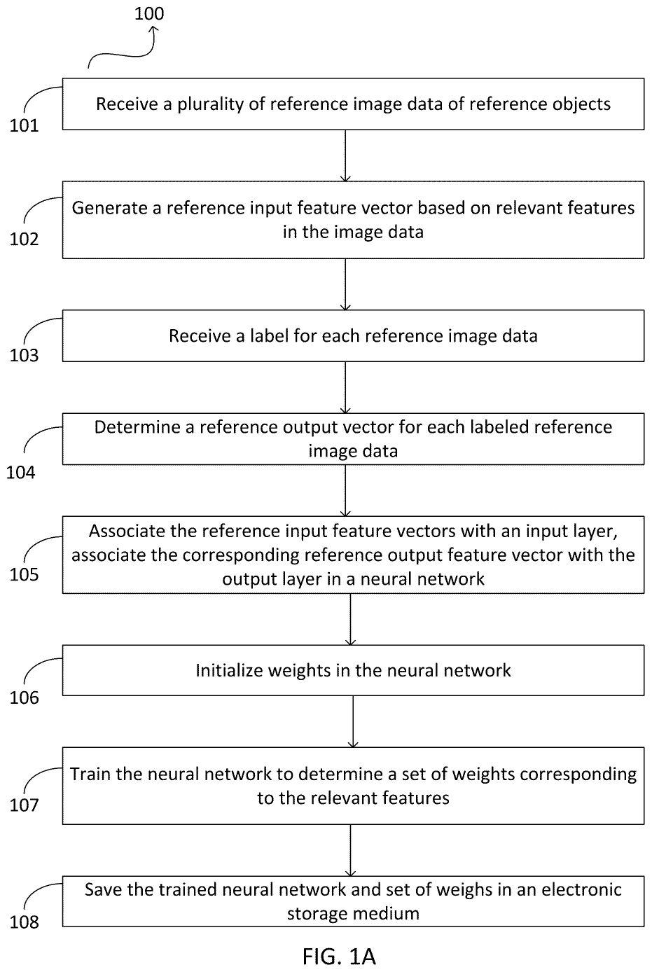

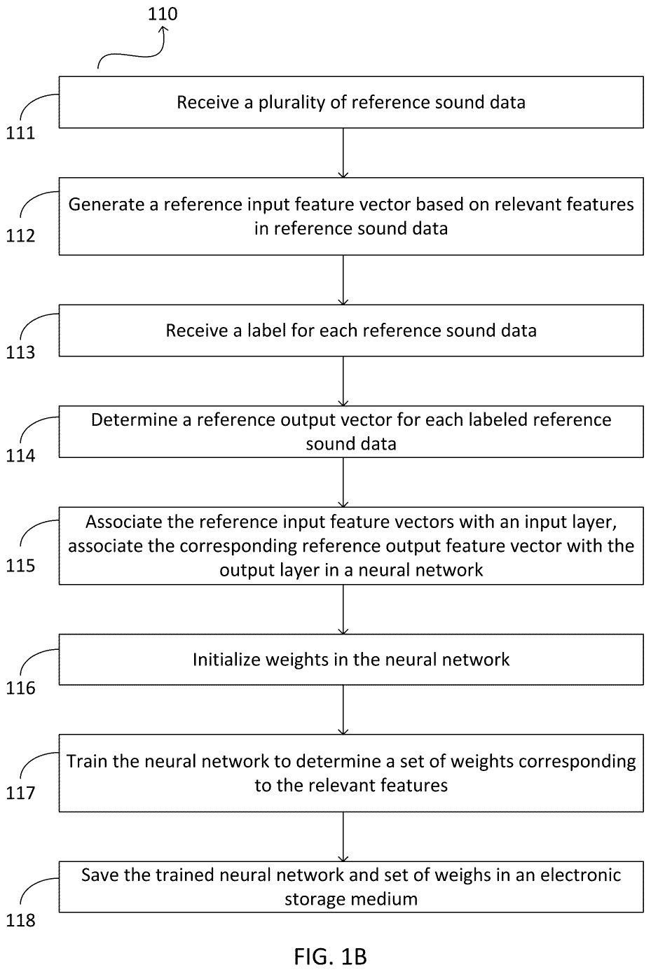

FIG. 1A shows a diagram of a method 100 of training a deep learning model for recognizing and generating labels for images according to embodiments herein. One or more steps of method 100 may be performed by a computing device having a processor. The device according to embodiments herein may have a processor embedded within the device. Alternatively, the device may be informationally connected to a processor. The processor may execute one or more steps in FIG. 1 based on computer-executable instructions stored in a memory device of the computing device.

Method 100 begins with the computing device receiving a plurality of reference image data of reference objects in step 101. Reference image data may be obtained from different sources to adequately reflect various objects, plants, animals, humans, and landscape often encountered in various living environments. Human living environment varies vastly, and each environment has specific natural landscape, animal, plant, and geographic and weather occurrences. Manmade conditions also affect the presence of certain objects, plants, animals, and buildings, among other features of the surrounding environment. The presence of these features also affects the sounds, lighting, and weather condition of the environment. Moreover, cultural features also affect the presence of certain objects, plants, animals, humans, buildings, and specific characteristics of these objects, plants, animals, humans, or buildings, among other features.

In step 102, the computing device may generate, for each of the plurality of reference image data, an input feature vector based on relevant features from the image data. For example, relevant features may include, but are not limited to, the color of an individual pixel of the image data, a contrast of an individual pixel in relation to neighboring pixels, a brightness of an individual pixel, a degree of similarity with a neighboring pixel, or a curvature. In some embodiments, for example, where a convolutional neural network model is to be implemented, the feature vectors may be automatically determined based on the convolved image data. In such embodiments, the relevant features may not necessarily be features that a human could relate to.

A machine learning model learns from training data and output a feature, such as a label comprising information, such as name, characteristics, or other information. The machine learning model according to embodiments herein processes an input, which may be an image of an animal often encountered in a suburban environment, such as a dog, and writing out a label in a computer-readable form. The label image of a dog may further be labeled with other characteristics, such as the breed, coat color, relative size of the dog, etc. The computing device thus receives reference images, with labels associated with each of the reference images in step 103.

In step 104, the computer device determines, for each labeled reference image data, output vectors based on the labels. The output vector may be information stored in computer readable form and transmitted to another software module for further processing using computer readable instructions.

In step 105, the computing device associates the input feature vectors with an input layer of a neural network model and associates the corresponding output vector with the output layer in the neural network model. A neural network stored in a computing device may have an input layer, which stores input information in nodes, and an output layer, which has nodes connected to the nodes in the input layer. The nodes within the output layers may also be connected to each other. The computing device thus input values from the output vector formed in block 104 on to the output later. The neural network model therefore formed from this method.

In step 106, the computing device initializes weights in the neural network model. Biases may be initialized and provided for any layer of the neural network model. The weights and biases may affect an activation function occurring at a node. As will be described, the weights and/or biases may be adjusted based on iterative processes in the training of the neural network model.

At block 107, the neural network model may be trained to determine a set of weights corresponding to the relevant features. A neural network model may be deemed trained, for example, if the model accurately assigns a label to an object captured in an image. A neural network model is trained, for example, if it yields an optimized set of weights for use in the application of the trained neural network. The optimized set of weights may be determined through iterative feedforward and backpropagation processes. In step 108, the trained neural network is saved (e.g., to cloud and/or an electronic storage medium) for use in identifying various objects, humans, animals, conditions, etc.

FIG. 1B shows a diagram of method 110 of training a deep learning model for recognizing and generating labels for sounds according to embodiments herein. One or more steps of method 100 may be performed by a computing device having a processor. The device according to embodiments herein may have a processor embedded within the device. Alternatively, the device may be informationally connected to a processor. The processor may execute one or more steps in FIG. 1B based on computer-executable instructions stored in a memory device of the computing device.

Method 110 begins with the computing device receiving a plurality of reference sound data of reference objects in step 111. Reference sound data may be obtained from different sources to adequately reflect various sounds emitted by objects, animals, humans, or environmental conditions, which are often encountered in various living environments. Human living environment varies vastly, and each environment has specific natural landscapes, animals, plants, and geographic and weather occurrences. Manmade conditions also affect the presence of certain objects, plants, animals, and buildings, among other features of the surrounding environment, and these can contribute to the emission of sounds in a certain environment. Moreover, cultural features also affect the presence of certain sounds, such as certain types of music, certain sounds from common animals at different places.

In step 112, the computing device may generate, for each of the plurality of reference sound data, an input feature vector based on relevant features from the raw sound data. In some embodiments, for example, where a convolutional neural network model is to be implemented, the feature vectors may be automatically determined based on the temporal raw speech. In such embodiments, the relevant features may not necessarily be features that a human could relate to.

A machine learning model learns from training data and output a feature, such as a label comprising information, such as name, characteristics, or other information. The machine learning model according to embodiments herein processes an input, which may be a soundtrack of a vehicle often encountered in a suburban environment, such as sirens from an ambulance, and writes out a label in a computer-readable form. The labeled sound may further be labeled with other characteristics, such as the volume, estimated distance, etc. The computing device thus receives reference sounds, with labels associated with each of the reference sounds in step 113.

In step 114, the computer device determines, for each labeled reference sound data, output vectors based on the labels. The output vector may be information stored in computer readable form and transmitted to another software module for further processing using computer readable instructions.

In step 115, the computing device associates the input feature vectors with an input layer of a neural network model and associates the corresponding output vector with the output layer in the neural network model. A neural network stored in a computing device may have an input layer, which stores input information in nodes, and an output layer, which has nodes connected to the nodes in the input layer. The nodes within the output layers may also be connected to each other. The computing device thus input values from the output vector formed in block 114 on to the output later. The neural network model therefore formed from this method.

In step 116, the computing device initializes weights in the neural network model. Biases may be initialized and provided for any layer of the neural network model. The weights and biases may affect an activation function occurring at a node. As will be described, the weights and/or biases may be adjusted based on iterative processes in the training of the neural network model.

At block 117, the neural network model may be trained to determine a set of weights corresponding to the relevant features. A neural network model may be deemed trained, for example, if the model accurately assigns a label to a soundtrack input into the neural network model. A neural network model is trained, for example, if it yields an optimized set of weights for use in the application of the trained neural network. The optimized set of weights may be determined through iterative feedforward and backpropagation processes. In step 118, the trained neural network is saved (e.g., to cloud and/or an electronic storage medium) for use in identifying various sounds.

The trained neural network for image recognition saved in step 108 and the trained neural network for sound recognition saved in step 118 are used for analyzing images and sounds recorded by a camera and a speaker. The result of analysis by these two neural networks is used as input into a content selection or content generation module within a device according to embodiments herein.

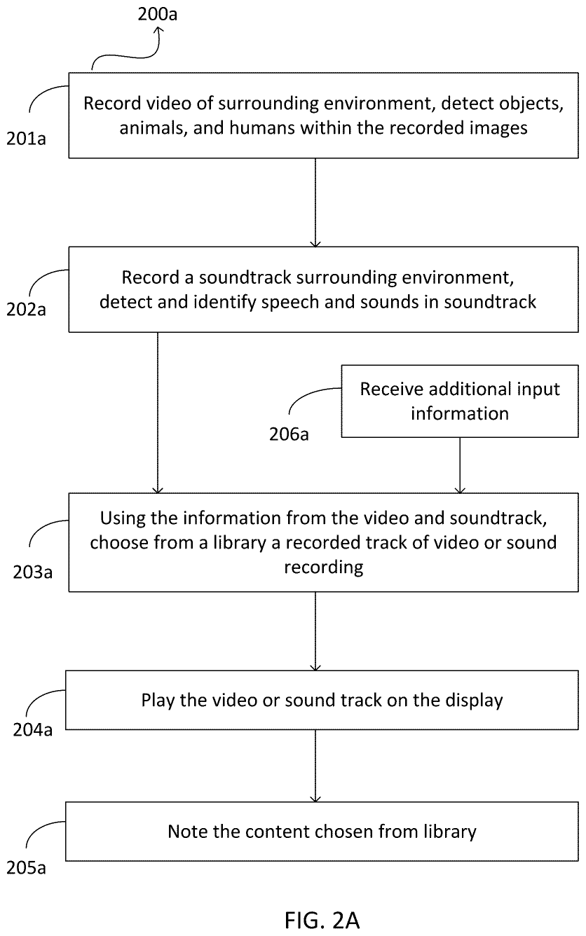

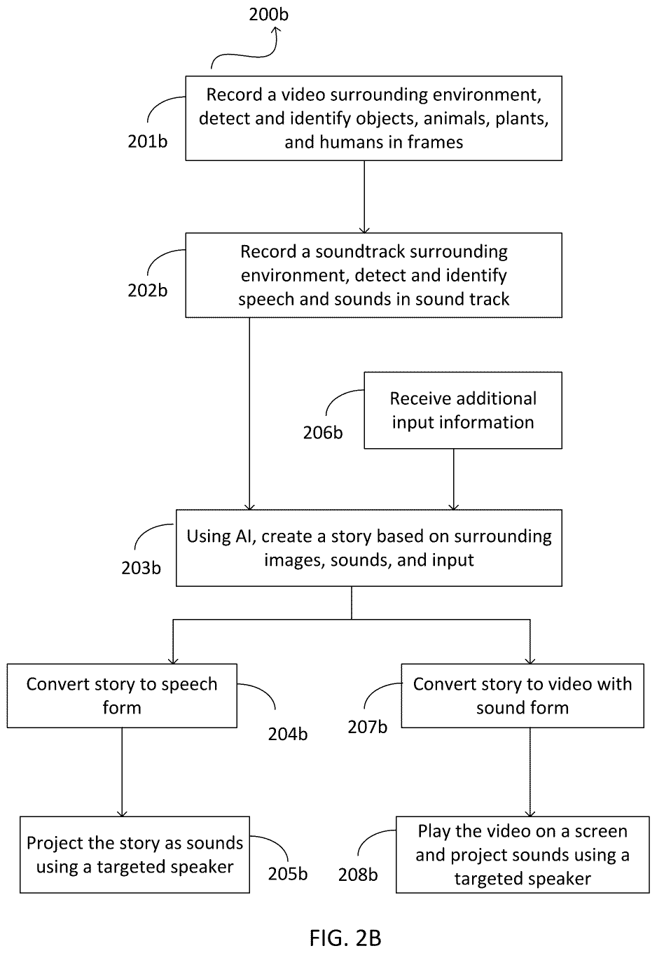

FIG. 2A illustrates a flowchart of a method to choose and deliver content on a device according to embodiments herein. Method 200a starts at step 201a, wherein a camera records a video of surrounding environments. The camera is one camera, or a collection of cameras, and records videos of the surrounding environments. Images recorded are saved as digital data and analyzed by the computer programming product to detect and identify objects, animals, plants, and human in frames. In particular, the first neural network saved in step 108 of FIG. 1 is used to analyze the images. Detected objects include inanimate objects, plants, animals, and humans. Inanimate objects are identified by their names, such as car, road, rock, traffic sign, bench, etc. Animals are identified by their common name, such as dog, cat, bird, rabbit, horse, turtle, elephant, etc. Plants are identified by their species, such as rose, grass, oak, juniper, dandelion, cactus, palm, bird of paradise, etc. Humans are identified as “human”. These identifications are categorized as identity data.

Next, objects identified are analyzed for characteristics of the objects. For example, humans are identified by their gender and age group, such as baby, young child, teenager, adult, or older adult. Other characteristics of objects, animals, plants, and humans are included, such as color, size, relative position with other objects in the same image, speed of movement (if any). Finally, environmental characteristics that can be deciphered from information collected, such as lighting, weather, time of day, or season, among other characteristics.

At step 202a, which can happen subsequently or concurrently with step 201a, the microphone records a soundtrack from the surrounding environment. Sounds recorded are saved as digital data and analyzed by the computer programming product using the second trained neural network saved in step 118 of FIG. 1B to detect and identify the nature of the sounds. Sounds are categorized as animal sounds, vehicle sounds, other sounds created by objects, sounds created by weather, human voices, or music. Other categories may be provided and are a part of an engineering decision. The identification of sounds is categorized as identity data of the sounds. For each sound, characteristics of the sounds are denoted, such as volume, changes in volume over time, or other characteristics typical to sounds. This is categorized as characteristic data of the sounds.

For human voices, a language comprehension module is provided to comprehend speech. Typically, speech sounds are transcribed into written form via a speech-to-text (STT) system, and the words are scanned by the computer programming product to evaluate the context and meaning of the language using furry logic, among other logics. Language recognition is provided in a selection of languages, and users can choose to set the device to a certain language for use.

Step 201a and step 202a can happen concurrently, subsequently, or only one of the two steps happens. However, at least one of the two steps needs to happen for the method in FIG. 2A to initialize. Image data, sound data, or both, from step 201a and/or step 202a are sent to step 203a for further processing.

The result of image recognition and sound recognition from step 201a and 202a are sent to step 203a, where the computer programming product chooses from a library of available content to broadcast to the screen and speaker. The available content may be in video form, still images, or sound recording only. The computer programming product has an algorithm to analyze the images and sounds recorded to decide which recorded content within the library to broadcast, as shown in step 204a.

Optionally, the method further includes step 206a, where the method receives information input by a user, such information is used as part of the selection process to choose content from the library. The information input may be age of the targeted audience, gender, content preference, such as music, cultural, scientific content, and other characteristics of a user or audience for content choice. Content library may include various age-specific content and thus content is grouped by age group. A user can input the age of an audience, who can be the user or another person or persons, and the method in FIG. 2A uses this information as part of the content selection process. Content may be grouped into specific age groups, such as 1-3 months, 3-6 months, 6-12 months, 1-2 years, and 2-4 years, 4-10 years, 11-16 years, 16 years and above, etc.

In embodiments, the method keeps track of which content has been broadcasted at which time and avoids broadcasting the same content repeatedly. This occurs in step 205a, when the content, after being played, is noted and the information is fed back into step 203a. This ensures that, even when the device is used in the same environment during approximately the same period, the user does not receive the same content broadcasted every time.

FIG. 2B illustrates a flowchart of a method to generate and deliver content on a device according to embodiments herein. Method 200b starts with step 201b, where the camera records a video of surrounding environment then analyzes the recorded images to detect and identify objects, animals, plants, and humans in frames. At step 202b, the microphone records a soundtrack of the surrounding environment then analyzes the recorded soundtrack to detect and identify sounds and speech. Steps 201b and 202b are the same as steps 201a and 202a in FIG. 2A. Step 201b and 202b can be conducted parallelly, subsequently, or only one of the two steps is conducted, but at least one step must be conducted at the initialization of method 200b.

The results of image and sound analysis from steps 201b and/or step 202b are fed into a content generation module in step 203b. At step 203b, the computer programming product takes the information identified from the image analysis and/or sound analysis and synthesizes a story using artificial intelligence. The neural network saved in step 108 of FIG. 1A and step 118 of FIG. 1B may be used in step 203b to generate a story with input from step 201b and/or step 202b.

Optionally, the method further includes step 206b, where the method receives information input by a user, such information is used as input for creating a story using AI. The information input may be age of the targeted audience, gender, content preference, such as music, cultural, scientific content, and other characteristics of a user or audience. A user can input the age of an audience, who can be the user or another person or persons, and the method in FIG. 2A uses this information as part of the content creation process. Content generated may be grouped into specific age groups, such as 1-3 months, 3-6 months, 6-12 months, 1-2 years, and 2-4 years, 4-10 years, 11-16 years, 16 years and above, etc.

After a story is generated in the content generation module, in step 204b, the story is converted to speech form to output as speech via a text-to-speech (TTS) system. The story is then projected to a user using a targeted speaker in step 205b.

Alternatively, after the story is generated in the content generation module, in step 207b, the story is converted to video form, with images and sounds. Sounds are generated via a TTS system. The story is then projected to the screen and the targeted speaker in step 208b.

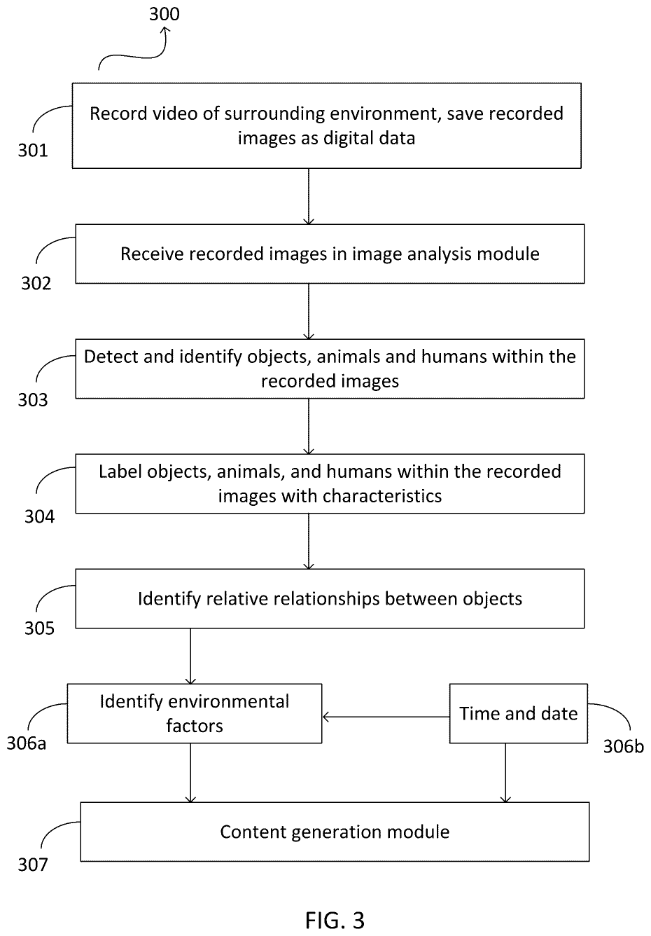

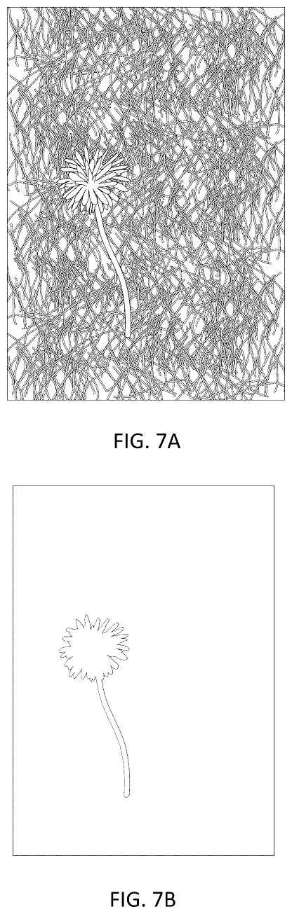

FIG. 3 depicts an image analysis module according to embodiments herein. A semantic segmentation model is trained to recognize pixels and match them with an image from memory library to attach a label to an image or a region of an image. FIG. 7A shows an example of input, which is a dandelion grown in a patch of grass, and FIG. 7B shows an example of output for semantic segmentation, which is the outlining shape of a dandelion. The output in FIG. 7B can also be used as training data, where such data is associated with a label, e.g. dandelion. During training, the image analysis module associates the training data with a label. During use, the image analysis module takes the image received from the camera and compares with an image from training data and associates the received image with a corresponding label.

The image analysis module 300 receives recorded images from the camera at step 301. The method according to embodiments herein may be set to record a video for a set length of time to obtain various images over the time length, such that adequate information about the surrounding environment can be acquired for analysis. For example, a person using this device walks on a sidewalk in a neighborhood, and the landscape changes after a few seconds. Adequate recording time can allow the device to record more images and thus provides more information to the computer programing product according to embodiments herein.

In step 302, the image analysis module 300 takes the images saved as digital data in the form of pixels and analyzes the image and regions within the image using image segmentation for contour determination or morphological skeletonization, thereby determining the identity of the object and associating the object detected with an identity, for example, inanimate objects such as house, building, car, truck, bicycles, motorbike, airplanes, road, sidewalk, rock, traffic sign, bench, stroller, table, chair, ball, kite, bags, backpack, shopping cart, computers, mountain, hill, fence, pond, river, creek, etc.; animals such as dog, cat, bird, squirrel, snake, dove, crow, hummingbird, rabbit, horse, turtle, donkey, goat, elephant, bison, buffalo, moose, deer, crocodile, etc.; plants such as rose, grass, oak, juniper, dandelion, cactus, pine, pumpkin, ash, grapes, tomatoes, corn, pear, apple, beech, palm, fig, mango, watermelon, cantaloupe, lemongrass, walnut, redwood, succulent, orange, lemon, pumpkin, chestnut, date, etc.; or human, among other labels. If a region of an image is not identifiable as within the available library of labels used for training, that region is marked as background.

In the next step 303, the image analysis module labels the identified images with characteristics. Characteristics of objects identified in images are provided as part of the functionality of the image analysis module. Characteristics include color, size, relative position with other objects identified in the same image, speed of movement of the object as determined between frames. Images identified as human have characteristics such as gender and age group associated with the images. Other characteristics can be included in the image analysis module.

In step 304, the image analysis module identifies relative relationships between identified objects. Relationships are relationships between humans, humans and animals, humans and objects, animals and animals, and animals and objects. For example, the image analysis module identifies a house, a grass area, and a rose bush. The distance between the rose bush and the house, and the placement of the rose bush in the grass area adjacent to the house indicates that the house has a grass yard with a rose bush in the grass yard. Similarly, the image analysis module may identify a dog, a human, and a rope attached to the dog and the human and draw a conclusion that the human is walking the dog on a leash.

The image analysis module 300 is also equipped with environmental characteristic analysis function, which is step 306a. Lighting conditions, presence of snow, sun light, rain, other indication of seasons such as leave colors are detected and identified. These characteristics, together with the time of day and the date as received by the computer programming product from an operating system and/or from an internal time piece 306b on the computing article, are used to analyze and draw conclusions about characteristics of the environment, such as time of day, weather condition, or season. Additionally, weather forecast information available from another application in the computing article may also supply information to the image analysis module 300.

In step 307, identities of objects, labels associated with identified objects, environmental characteristics, and relative information between objects identified are sent to a content generation module. The content generation module uses the information received as input and/or prompt to generate content for outputting on the device screen and speaker. The content generated may be in video form, sound form, or still images embedded with sounds.

Recording of videos may be started at the initialization of the method, when another content generation is requested, or continuous and parallel with the content generation module. When a video is recorded parallel with the content generation module outputting a story, image data is continuously analyzed by the image analysis module. Data about newly identified images are continuously sent to the content generation module for content generation purposes.

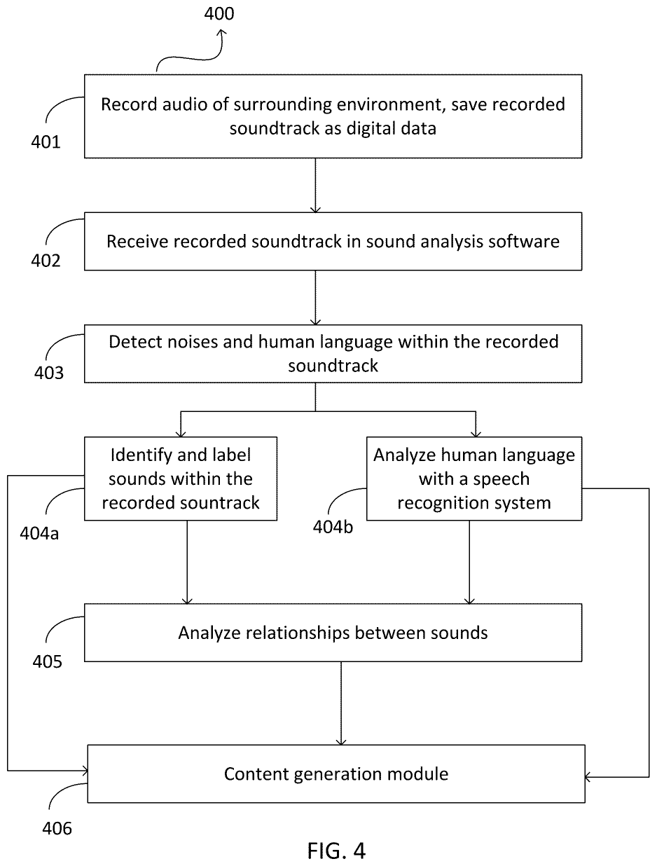

FIG. 4 depicts a soundtrack analysis module 400 according to embodiments herein. At step 401, a microphone records sounds from the surrounding environment and saves the soundtrack as digital data. The time length of the soundtrack is also set such that the microphone has a certain amount of time to pick up sounds from surrounding environments.

The soundtrack saved as digital data is then sent to and received in a sound analysis software in step 402. In step 403, the sound analysis software analyzes the soundtrack to identify the sounds within the soundtrack. Initially, the sound analysis software labels the sounds as noise or human language. In step 404a, the sound analysis software continues the analysis with sounds, and the sounds are given labels as identities, such as car engine sound, dog bark, baby crying, children playing, bird chirping, or sirens. The sounds are given characteristics, such as volume, whether the sounds come from one or multiple sources. The sounds are given identity data and characteristic data, such as “car engine sound, from multiple cars, nearby”, and the identity data and characteristic data are sent to the content generation module.

In step 404b, a speech recognition system converts speech into digital data. The data is then analyzed for meaning and context and information is drawn from the spoken language. The information includes, but is not limited to, gender of the person speaking, age group (child or adult), and information spoken by the person. This information, as digital data, is sent to the content generation module 406.

In step 405, the relationships between identified sounds are analyzed. Information concerning relationships drawn from the presence of sounds can also be discerned by analysis of the presence of sounds. For example, the sounds of music, many people chatting, and footsteps at the same time are analyzed and labeled “festival”. The sounds of people cheering loudly and announcers making announcements about sport games at the same time are analyzed and labeled as “sport games”. This analysis result is relationship data that the sound analysis module in step 405 outputs. Data from this analysis is sent to content generation module 406.

If the sound data received by the method herein does not contain any discernible sound, the method can send a notification to the content generation that no sound information is detected, and thus the content generation module does not use any information from the sound data in its content generation.

Recording of sounds may be started at the initialization of the method, when another content generation is requested, or continuous and parallel with the content generation module. When sound is recorded parallel with the content generation module outputting a story, sound data is continuously analyzed by the sound analysis module. Data about newly identified sounds are continuously sent to the content generation module for content generation purposes.

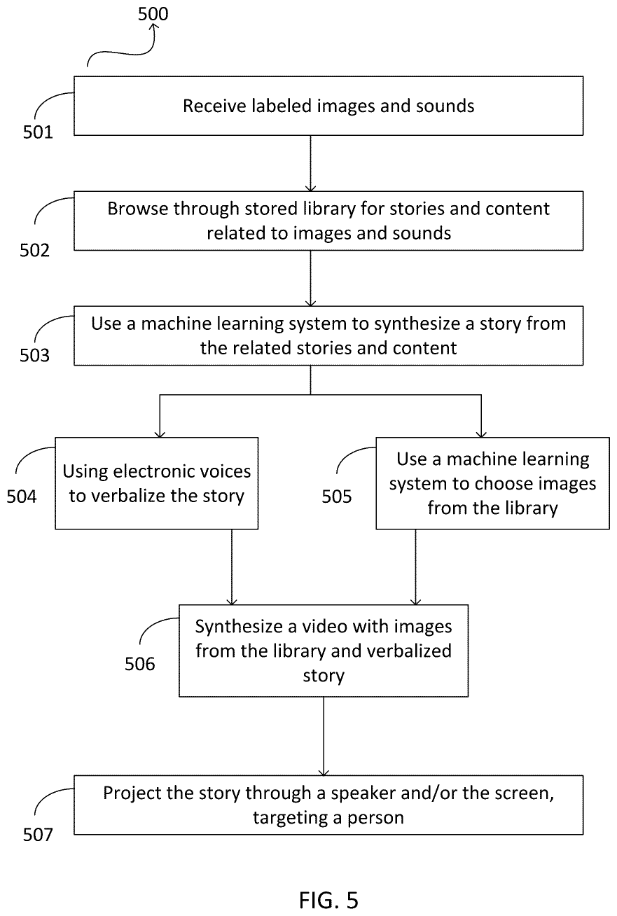

FIG. 5 illustrates a content generation module according to embodiments herein. The content generation module 500 receives information from the camera and microphone as processed by the image analysis module depicted in FIG. 3 and the soundtrack analysis module depicted in FIG. 4, in step 501. Information received from these modules includes identity data of objects, animals, and humans; characteristic data of objects, animals, and humans; relationships between objects, animals, and humans; environmental information; location; time and date; and weather forecast, among other information.

With these inputs, in step 502, the content generation module browses through a stored library for stories and content related to images and sounds as detected from the camera and microphone. Using a machine learning system, in step 503, the content generation module synthesizes a story, using the related stories and content identified in step 502. The story is generated as digital data, which is converted into text and transformed into speech through a text to speech system in step 504. The speech is broadcasted to the targeted speaker on the device in step 507.

Alternatively, the content generation module 500 uses the machine learning system to choose images from the library in step 505. Choices are made with a pre-determined set of rules built into the machine learning system. The chosen images are combined with the story synthesized in step 503 to synthesize a video in step 506. The images broadcasted to the screen while the story is broadcasted to the targeted speaker in step 507.

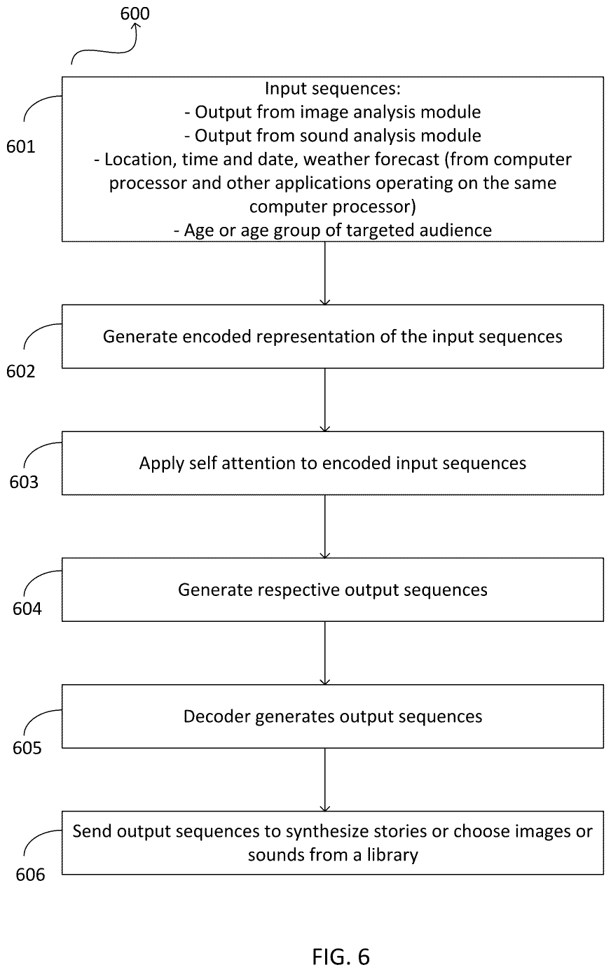

FIG. 6 illustrates a machine learning system 600 configured to perform step 503 and/or step 505 of FIG. 5. The machine learning system mentioned in steps 503 and 505 and illustrated in FIG. 6 may be a neural network, with an encoder neural network to receive input sequences in step 601 and generate encoded representations of the input sequences in step 602, the encoder neural network having sub networks; an encoder self-attention sub layer to receive subnetwork input and apply a self-attention mechanism over the encoder subnetwork inputs in step 603 to generate the respective outputs in step 604; and a decoder neural network configured to receive the encoded representations and generate the output sequence in step 605. The input sequences herein may be output from the image analysis module depicted in FIG. 3 or the sound analysis module depicted in FIG. 4. Additional input sequences may include location, time and date, and weather forecast information from other sources. Input sequences may also include the age or age group of the targeted audience. The output sequences may include text sequences, which can be verbalized by a text-to-speech system. The output sequences may include speech sequences. The output sequences may include image sequences. In step 606, the machine learning system 600 sends output sequences to synthesize stories or to choose images or sounds from a library.

The machine learning system may be configured to ignore input sequences marked as negative input. If an image of an accident is recorded by the video and the image analysis module 300 deciphers that an accident scene is present in the vicinity of the method according to embodiments herein, the image analysis module 300 may mark the input sequences as “negative” and does not feed this input sequence to the content generation module 500, such that a story containing “accident” is not generated. Additionally or alternatively, a “negative” input sequences may be recognized by the content generation module 500 as a warning, and the content generation module 500 may send a message to a user to change route and/or leave the scene.

The machine learning system may be configured to tailor the content generated using age or age group of the targeted audience, the age or age group is input by a user. The age groups include 1-3 months, 3-6 months, 6-12 months, 1-2 years, and 2-4 years, 4-10 years, 11-16 years, 16 years and above. Ages can be grouped into different groups than above. In an exemplary embodiment, for the age group of 1-3 months old, the machine learning system may be configured to generate content with simple information using simple music similar to lullabies. For the age group of 2-4 years old, stories with fully developed characters are generated. For 16 years old and above, content with scientific discussion is generated.

Once a story, either with or without audio content, or a recording, either audio or video, has been broadcasted to the speaker and/or the screen, the method according to embodiments herein may start another video and/or audio recording of the surrounding environment and conduct the steps in FIGS. 2A & 2B to create another story and/or choose another recording from the library and broadcast this other story to the screen and/or speaker.

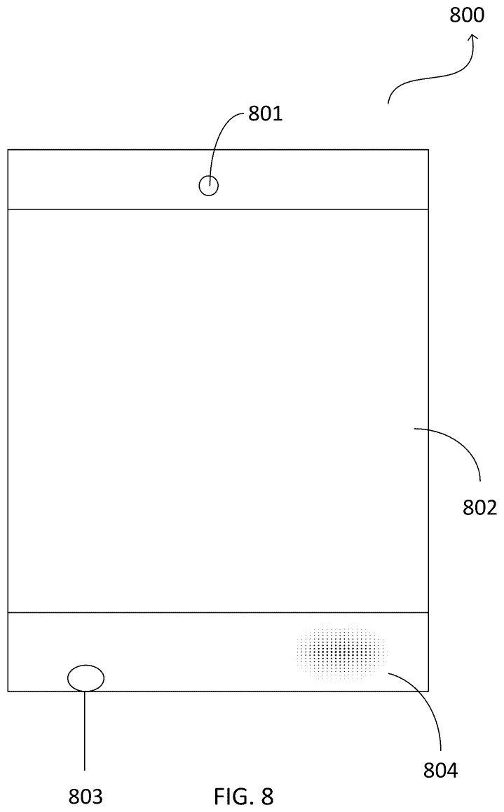

FIG. 8 illustrates a device according to embodiments herein. The device 800 comprises a camera 801 for recording images, a microphone for recording sounds 803, a speaker for projection of sound 804, a screen for projection of videos or still images 802. A computing device to execute a computer programming product according to embodiments herein is provided within device 800. Components of this device can be incorporated into a smartphone, a tablet, or other computing devices.

This method is executed or executable in a computing environment on a standalone computing article or a computing article connected to the Internet. This method may be made available as a downloadable application on a mobile computing device, such as a smartphone, a tablet, a laptop, or a desktop. The downloadable application may also be integrated into a computing article available on a vehicle, furniture, or other household implements.

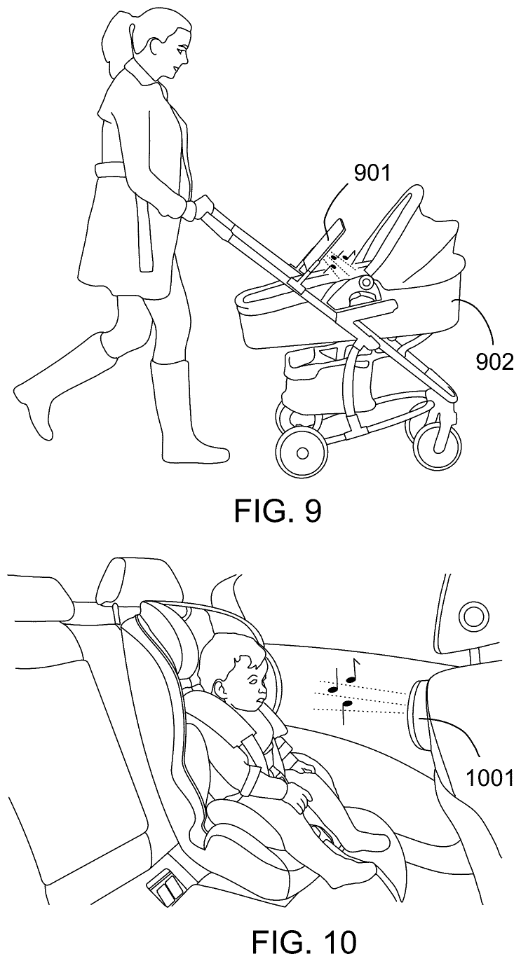

FIG. 9 illustrates an embodiment of a device configured to conduct a method as disclosed herein. The device is a tablet 901 configured to be attached to a stroller 902, such that the screen is viewable by an infant sitting inside the stroller 902. Cameras are available on the tablet 901 and can capture images of the surrounding environment. Microphones are also available on the tablet 901 and can capture sounds from the surrounding environment. The tablet 901 may be provided as part of the stroller 902. Alternatively, the tablet 901 may be a tablet used for other purposes and the method is available as an application installed on the tablet 901. In another embodiment, cameras and microphones can be integrated into the stroller and record images and sounds, then communicate with the tablet 901 to send image data and sound data to the tablet 901 for processing according to the method disclosed herein.

FIG. 10 illustrates an embodiment where only audio is played, such that a screen is not shown and only sounds are broadcasted from a speaker 1001 integrated into the front passenger seat. In these embodiments, cameras on the vehicle may be connected to the application on the vehicle's computer or the mobile computing device, such that image data can be recorded from those cameras. A computing device integrated into the vehicle, or another computing device can conduct the method according to embodiments herein, and the content generated by the method is broadcast on speaker 1001 as shown in FIG. 10. The speaker 1001 integrated into the passenger seat may be a targeted speaker, such that only the child can perceive the sounds broadcasted from the speaker.

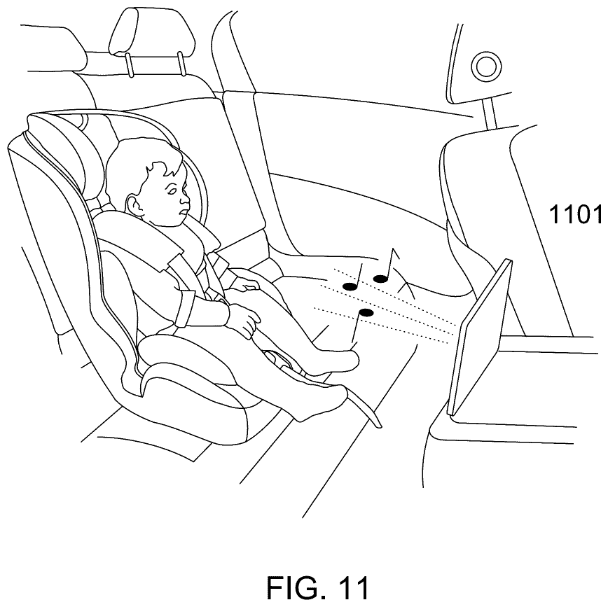

FIG. 11 illustrates another embodiment of a device configured to conduct a method as disclosed herein. The device is integrated into a vehicle, namely, a car or SUV. The screen is integrated as a pop-up from the middle console, while the speaker (not shown) is integrated into the back of the front passenger seat or into the screen 1101. An infant sitting in the child seat in the back can view the content generated at the pop-up screen 1101, while the sound is projected from the speaker. The speaker may be a targeted speaker, such as a parametric speaker, projecting sound to the infant while the driver and passenger in the front seat cannot hear the content. Alternatively, the speaker can be integrated into the screen 1101. The method to generate content for the infant may be available as a part of the computer on the vehicle, or it can be available as an installed application on a mobile computing device such as a smartphone, and the application is connected to the car via Carplay. The application may be used in different modes, including audio only, video and audio, or video only.

### EXAMPLES

### Example 1

A person pushing a stroller with a device according to embodiments herein attached to the handle of the stroller. Camera(s) on the device record images of the surrounding environment and identify that yellow leaves are falling, and pumpkins are present on the lawn of houses. The microphone(s) record noises and identify several cars passing by and dogs barking. An internal time piece sends information about the date and time to the computer programming product installed in the device. The computer programming product receives the above information in the form of identity (leaves, pumpkins, houses, cars, dogs), characteristics (yellow leaves, orange pumpkins), relative positions between objects (pumpkins near a house), environment characteristics (leaves falling, the month being October), and choose from a library of content. The matching story is the story of Jack-o'-lantern and the origin of Halloween. The device then broadcasts this story in the form of video and sounds through the screen and the targeted speaker to a baby sitting in the stroller.

### Example 2

The device receives the same information as in Example 1, but a machine learning module is activated. The machine learning module synthesizes a story about a kid going trick-or-treating with their friends on Halloween day, when they ran into dogs barking as they approached the house. The kids then retreat and leave to avoid being near an aggressive dog. The device uses an electronic voice to verbalize the story and tell the story to a user, who can be a baby inside the stroller.

### Example 3

The device detects multiple, continuous images of pine trees and a small trail using the image analysis module. The sound analysis module only picks up faint sounds of footsteps. The device synthesizes a story concerning pine, its evolution history, biological characteristics, scientific facts, usage by humans, and cultural significance. The device broadcasts this story to a user via a speaker.

In a first embodiment, a method to generate content to be broadcasted is provided, the method comprises:
recording, using a camera, a video of a surrounding environment and saving the video as image data;
receiving, by a computing device having a processor, image data of the video;
applying the image data to a first trained neural network model to identify objects present in the image data and identify characteristics of the objects;
associating the identified objects with image identity data and image characteristic data;
inputting the identity data and characteristic data of the objects to an artificial intelligence software to generate content; and
broadcasting the content to a speaker and/or screen,
wherein the content is in audio form, image form, or image form with an associated soundtrack.

In a second embodiment, the first embodiment further comprises:
recording, using a microphone, a soundtrack of a surrounding environment and saving the soundtrack as sound data;
receiving, by the computing device having a processor, the sound data of the soundtrack;
applying the sound data to a second trained neural network model to identify sounds present in the sound data and identifying characteristics of the sounds;
associating the identified sounds with identity data and characteristic data;
inputting the identity data and characteristic data of the sounds to an artificial intelligence software to generate content.

In a third embodiment, the first embodiment further comprises marking regions of image data not associated with an identity label as background.

In a fourth embodiment, the first embodiment includes identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple.

In a fifth embodiment, the first embodiment includes characteristic data of objects comprises color, size, relative position with other objects in the same image, speed of movement of a particular object, age group, gender.

In a sixth embodiment, the first embodiment includes analyzing the identity data and characteristic data for environmental condition and relationship data.

In a seventh embodiment, the sixth embodiment includes the environmental condition is weather condition and lighting condition, and wherein the relationship data is relationship between humans, humans and animals, humans and objects, animals and animals, and animals and objects.

In an eighth embodiment, the first embodiment includes the identity data and characteristic data are inputted into the artificial intelligence software to choose from a library content.

In a ninth embodiment, the first embodiment further comprises receiving additional information from a computer processor and inputting the additional information into the artificial intelligence software to generate content.

In a tenth embodiment, the ninth embodiment includes the additional information comprises time and date, location, weather forecast, and age or age group of a targeted audience.

In an eleventh embodiment, the tenth embodiment further comprises marking a part of at least one of identity data, characteristic data, and relationship data as negative input and preventing negative input from being sent to the artificial intelligence software.

In a twelfth embodiment, the first embodiment includes the video recording is continuous in real time and image data is received in real time, and wherein the sound recording is continuous in real time and sound data is received in real time.

In a thirteen embodiment, a system for content selection and generation for human consumption is provided, the system comprises:
a camera;
a processor;
a screen;
a speaker; and
a memory device storing computer-executable instructions that, when executed by the processor, causes the processor to:
   record, using the camera, a video of a surrounding environment and save the video as image data;
   apply the image data to a first trained neural network model to identify objects present in the image data and identify characteristics of the objects;
   associate the identified objects and humans with identity data and characteristic data;
   input the identity data and characteristic data of the objects to an artificial intelligence software to generate content;
   record, using a microphone, a soundtrack of a surrounding environment and save the soundtrack as sound data;
   apply the sound data to a second trained neural network model to identify sounds present in the image data and identify characteristics of the sounds and associating the objects and humans;
   associate the identified sounds with identity data and characteristic data;
   input the identity data and characteristic data of the sounds to an artificial intelligence software to generate content; and
   broadcast the content to the speaker and/or the screen,
wherein the content is in audio form, image form, or image form with an associated soundtrack.

In a fourteenth embodiment, the thirteenth embodiment includes identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple and wherein characteristic data of objects comprises color, size, relative position with other objects in the same image, speed of movement of a particular object, age group, gender.

In a fifteenth embodiment, the thirteenth embodiment includes the memory device further causes the processor to analyze the identity data and characteristic data for environmental condition and relationship data.

In a sixteenth embodiment, the fifteenth embodiment includes the environmental condition is weather condition and lighting condition, and wherein the relationship data is relationship between humans, humans and animals, humans and objects, animals and animals, and animals and objects.

In a seventeenth embodiment, the thirteenth embodiment includes the memory device causes the processor to input the identity data and characteristic data into the artificial intelligence software to choose from a library content.

In an eighteenth embodiment, the thirteenth embodiment includes the processor records the video and the soundtrack in real time.

In a nineteenth embodiment, the thirteenth embodiment includes the memory device further causes the processor to receive additional information from a computer processor and input the additional information into the artificial intelligence software to generate content.

In a twentieth embodiment, the nineteenth embodiment includes the additional information comprises time and date, location, weather forecast, and age or age group of a targeted audience.

While the present invention has been discussed in detail with reference to certain embodiments, other embodiments are possible. Therefore, the scope of the appended claims should not be limited to the description of the preferred embodiments contained in this disclosure.

All references, including publications, patent applications, and patents cited herein are hereby incorporated by reference to the same extent as if each reference were individually and specifically indicated to be incorporated by reference and were set forth in its entirety herein.

It will be readily apparent to those skilled in the art that a number of modifications and changes may be made without departing from the spirit and the scope of the present invention. It is to be understood that any ranges, ratios, and range of ratios that can be derived from any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art will appreciate that such values are unambiguously derivative from the data presented herein.

1. A method to generate content to be broadcasted, comprising:
recording, using a camera, a video of a surrounding environment and saving the video as image data;
receiving, by a computing device having a processor, image data of the video;
applying the image data to a first trained neural network model to identify objects present in the image data and identify characteristics of the objects;
associating the identified objects with image identity data and image characteristic data;
receiving additional information from a computer processor;
inputting the identity data and characteristic data of the objects and the additional information into an artificial intelligence software to generate content; and
broadcasting the content to a speaker and/or screen,
wherein the content is in audio form, image form, or image form with an associated soundtrack.

2. The method of claim 1, further comprising:
recording, using a microphone, a soundtrack of a surrounding environment and saving the soundtrack as sound data;
receiving, by the computing device having a processor, the sound data of the soundtrack;
applying the sound data to a second trained neural network model to identify sounds present in the sound data and identifying characteristics of the sounds;
associating the identified sounds with identity data and characteristic data;
inputting the identity data and characteristic data of the sounds to an artificial intelligence software to generate content.

3. The method of claim 1, further comprising marking regions of image data not associated with an identity label as background.

4. The method of claim 1, wherein identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple.

5. The method of claim 1, wherein characteristic data of objects comprises color, size, relative position with other objects in the same image, speed of movement of a particular object, age group, gender.

6. The method of claim 1, further comprising analyzing the identity data and characteristic data for environmental condition and relationship data.

7. The method of claim 6, wherein the environmental condition is weather condition and lighting condition, and wherein the relationship data is relationship between humans, humans and animals, humans and objects, animals and animals, and animals and objects.

8. The method of claim 1, wherein the identity data and characteristic data are inputted into the artificial intelligence software to choose from a library content.

9. (canceled)

10. The method of claim 1, wherein the additional information comprises time and date, location, weather forecast, and age or age group of a targeted audience.

11. The method of claim 10, further comprising marking a part of at least one of identity data, characteristic data, and relationship data as negative input and preventing negative input from being sent to the artificial intelligence software.

12. A method to generate content to be broadcasted, comprising:
recording, using a camera, a video of a surrounding environment and saving the video as image data;
receiving, by a computing device having a processor, image data of the video;
applying the image data to a first trained neural network model to identify objects present in the image data and identify characteristics of the objects;
associating the identified objects with image identity data and image characteristic data
inputting the identity data and characteristic data of the objects into an artificial intelligence software to generate content; and
broadcasting the content to a speaker and/or screen,
wherein the content is in audio form, image form, or image form with an associated soundtrack, and
wherein the video recording is continuous in real time and image data is received in real time, and wherein the sound recording is continuous in real time and sound data is received in real time.

13. A system for content selection and generation for human consumption, the system comprising:
a camera;
a processor;
a screen;
a speaker; and
a memory device storing computer-executable instructions that, when executed by the processor, causes the processor to:
record, using the camera, a video of a surrounding environment and save the video as image data;
apply the image data to a first trained neural network model to identify objects present in the image data and identify characteristics of the objects;
associate the identified objects and humans with identity data and characteristic data;
input the identity data and characteristic data of the objects to an artificial intelligence software to generate content;
record, using a microphone, a soundtrack of a surrounding environment and save the soundtrack as sound data;
apply the sound data to a second trained neural network model to identify sounds present in the image data and identify characteristics of the sounds and associating the objects and humans;
associate the identified sounds with identity data and characteristic data;
receive additional information from a computer processor;
input the identity data and characteristic data of the sounds and the additional information into an artificial intelligence software to generate content; and
broadcast the content to the speaker and/or the screen,
wherein the content is in audio form, image form, or image form with an associated soundtrack.

14. The system of claim 13, wherein identity data of objects comprise building, car, truck, bicycles, motorbike, airplanes, road, sidewalk, rock, traffic sign, bench, stroller, table, chair, ball, kite, bags, shopping cart, computers, dog, cat, bird, squirrel, snake, dove, crow, hummingbird, rabbit, horse, turtle, donkey, goat, human, elephant, rose, grass, oak, juniper, dandelion, cactus, pine, pumpkin, ash, grapes, tomatoes, corn, pear, apple and wherein characteristic data of objects comprises color, size, relative position with other objects in the same image, speed of movement of a particular object, age group, gender.

15. The system of claim 13, wherein the memory device further causes the processor to analyze the identity data and characteristic data for environmental condition and relationship data.

16. The system of claim 15, wherein the environmental condition is weather condition and lighting condition, and wherein the relationship data is relationship between humans, humans and animals, humans and objects, animals and animals, and animals and objects.

17. The system of claim 13, wherein the memory device causes the processor to input the identity data and characteristic data into the artificial intelligence software to choose from a library content.

18. The system of claim 13, wherein the processor records the video and the soundtrack in real time.

19. (canceled)

20. The system of claim 13, wherein the additional information comprises time and date, location, weather forecast, and age or age group of a targeted audience.
